(19) United States
(12) Patent Application Publication
(10) Pub. No.: US 2019/0136879 A1
(43) Pub. Date: May 9, 2019

(54) HYDRAULIC SYSTEM CONTROL PLATE

(71) Applicant: REINZ-DICHTUNGS-GMBH, NEU-ULM (DE)

(72) Inventors: MATTHIAS PENDZIALEK, ULM (DE); HARALD REBIEN, NEU-ULM (DE); JUERGEN SCHNEIDER, MERKLINGEN (DE)

(73) Assignee: REINZ-DICHTUNGS-GMBH, NEU-ULM (DE)

(21) Appl. No.: 16/096,708

(22) PCT Filed: Apr. 28, 2017
(86) PCT No.: PCT/EP2017/060228

§ 371 Date: Oct. 26, 2018

(30) Foreign Application Priority Data
Apr. 28, 2016 (DE) 20 2016 102 266.5

(51) Int. Cl. F15B 13/08; F16H 61/00; F16J 15/08

(52) U.S. Cl. CPC F15B 13/081; F16H 61/0009; F16J 2015/0875; F16J 15/0818; F16J 2015/0856; F16J 15/0806

(57) ABSTRACT

A hydraulic system control plate with at least three layers, at least one through-opening being introduced in an inner one of the three layers and being delimited, on at least one part of its surface in the inner layer, by the two other layers is disclosed. A method for producing such a hydraulic system control plate is disclosed.

The invention relates to a hydraulic system control plate with at least three layers, at least one through-opening being introduced in an inner one of the three layers and being delimited, on at least one part of its surface in the inner layer, by the two other layers. Furthermore, the invention relates to a method for producing such a hydraulic system control plate.

Hydraulic system controls, such as for example transmission controls, normally have two housing halves, optionally also more housing parts, which are separated by a hydraulic system control plate, in the case of transmissions, a transmission control plate. The housing halves or housing parts are thereby sealed by the hydraulic system control plate. In the state of the art, the seal of the housing halves or housing parts is effected by one or more layers of aluminium- or steel sheet of the hydraulic system control plate being provided with sealing elements in the form of beads and/or with coatings made of rubber mixtures.

The hydraulic system control plate thereby normally has through-openings through which hydraulic fluid can flow from the one housing half into the other housing half or from one housing part into another housing part. In the state of the art, the throughflow direction through these holes is thereby perpendicular to the plane of the layers of the hydraulic system control plate.

DE 10 2012 202 759 A1 describes an intermediate plate for transmission controls in which the control plate has three layers, a channel-like recess being stamped into the inner one of the layers. Normally, the connection of the layers here is undertaken in a step which is independent of a seal. As a result, the production of such intermediate plates is very complex. Furthermore, it is not possible with current connection methods to avoid gaping in the region of the channels as a result of pressure changes. The contour course of adjacent channels is, in addition, often so narrow that there is insufficient constructional space for accommodating beads or sealing beads along all the channel edges.

It is the object of the present invention to indicate a hydraulic system control plate in which gaping of the relevant layers relative to each other in the regions adjacent to the channels is prevented. In addition, also no special sealing of the layers relative to each other should preferably be required. Furthermore, it should preferably be possible to dispose channels very closely to each other, and also, if required, to enable an interference-free intersection of channels. Preferably, the hydraulic system control plate should be producible in a simple and economic manner. Therefore, a further object of the present invention is to indicate a method with which a hydraulic system control plate can be produced in a simple and economic manner.

The object is achieved by the hydraulic system control plate according to claim 1 and the method for producing a hydraulic system control plate according to claim 21. The respective dependent claims indicate advantageous developments of the hydraulic system control plate according to claim 1 and of the method according to claim 21.

According to the invention, a hydraulic system control plate is provided, which has at least one first layer, at least one second layer and at least one inner layer disposed between the first layer and the second layer. The at least one inner layer thereby has at least one through-opening, which penetrates the inner layer. An opening surface of this through-opening extends therefore in the surface of the inner layer. According to the invention, the through-opening in the inner layer is delimited, on at least one part of its extension, by the first layer and the second layer in a direction perpendicular to the surface of the inner layer.

Preferably, the layers are planar so that the mentioned surfaces are advantageously planar.

Preferably, the layers are disposed adjacent to each other.

Advantageously, the hydraulic system control plate according to the invention, in addition to the three mentioned layers, also the at least one inner layer falling within the scope of the present invention under the term layer, can have one or more further layers which are disposed on one side of the first layer, orientated away from the inner layer, and/or on a side of the second layer, orientated away from the inner layer. Advantageously, one, more or all of the mentioned further layers respectively can thereby delimit a through-opening in one or both adjacent ones of the layers on at least one part of the extension of this through-opening in the direction perpendicular to the surface of the corresponding adjacent layer. The corresponding adjacent layer of one given layer is thereby that one of the layers which is nearest the given layer in the direction perpendicular to the surface of the layer.

The hydraulic system control plate according to the invention therefore has at least three of the layers, namely the mentioned first layer, the second layer and the at least one inner layer, however can in addition have further layers so that it can have in total advantageously also four, five, six, seven, eight or more layers.

The mentioned further layers can advantageously have at least one through-opening which overlaps with one of the through-openings of an adjacent one of the layers, in particular in portions, and/or abuts on a through-opening of an adjacent one of the layers in a fluid-permeable manner.

If any number of layers is assumed, it is preferred if each of the layers has at least one through-opening which overlaps with respectively at least one through-opening of all immediately adjacent ones of the layers in a fluid-permeable manner, which through-openings of the adjacent layers respectively in turn overlap with a through-opening of the other adjacent layer of this layer in a fluid-permeable manner. Preferably, respectively at least one through-opening of all the layers together form a fluid-permeable channel which opens outwards, on the one hand, in an outermost of the layers and, on the other hand, in the opposite outermost of the layers outwards. The channel therefore allows throughflow of fluid from one side of the hydraulic system control plate to the opposite side of the hydraulic system control plate. The overlap thereby needs merely to be effected in a fluid-permeable manner, complete overlapping is possible but generally overlapping in portions is sufficient.

If at least five layers are provided, the through-openings in various of those ones of the layers which abut on both sides on others of the layers, can also intersect. If those ones of the layers, the through-openings of which intersect, are separated from each other by at least one further one of the layers, channel portions which intersect can be produced.

If the hydraulic system control plate has precisely the mentioned first layer, the second layer and the inner layer, then advantageously the first layer and/or the second layer have at least one through-opening which overlaps with the mentioned at least one through-opening of the inner layer and/or abuts on this through-opening of the inner layer in a fluid-permeable manner. It is therefore particularly preferred if the first and the second layer respectively have a through-opening which do not mutually overlap, however nevertheless communicate with each other fluidically via the inner layer. Preferably, respectively the outer layers of the layer system forming the hydraulic system control plate, having the first and second layer, the inner layer and all possible further layers, have in this way openings which do not overlap so that the hydraulic system control plate is an intermediate plate through which the fluid can be conducted from the one outer surface of the hydraulic system control plate to the opposite other surface of the hydraulic system control plate, the entry point on the one outer surface relative to the exit point on the opposite other surface being offset mutually, preferably in the direction parallel to the plane of a layer.

There is understood here preferably by overlapping of openings that the opening surfaces of the openings under consideration, in the case of a projection in the direction perpendicular to the surface of the layers in which the openings are present, mutually overlap, i.e. the projections intersect.

According to the invention, one, more or all of the layers comprise aluminium or consist thereof. According to the invention, in addition two adjacent ones of the layers or all of the layers adjacent in pairs are soldered together at least in regions.

It is thereby preferred if one, more or all of the layers, on at least one part of those of its surfaces which are orientated towards other ones of the layers, comprise aluminium solder and/or ceramic solder at least in regions or on all of these surfaces. The mentioned solder on the corresponding surface can therefore cover only a part of the surface which is not identical to the entire surface or else also cover the entire surface. In particular in the case of a planar coating with solder, it is preferred if the solder coating thereby has advantageously a layer thickness of 5 to 20% of the thickness of the relevant layer on one surface, advantageously between 10 and 150, in particular between 20 and 80 μm.

In an advantageous embodiment, the soldering can be undertaken as follows. In a first step, the solder can be applied on at least one metal sheet from which the layers are intended to be produced. From the metal sheet or sheets, then the individual layers can be produced, for example by means of stamping. Advantageously, the layers are then fixed or pressed one on the other by means of a force in order to produce good contact of the soldering points. Surfaces which are both coated with solder can thereby be disposed one on the other, or the surfaces can be disposed such that only one of the adjacent surfaces is coated with solder. Also layers which are not coated with solder can thereby be integrated if they come to lie adjacent to a layer which has a solder coating.

The layers can now advantageously be warmed or heated up to a melting temperature of the solder, for example to 540° C. to 610° C. Advantageously, the melting temperature of the material from which the layers are produced, i.e. the material of the mentioned metal sheets, should be higher than the melting temperature of the solder, for example 650° C.

It is particularly preferred if at least two adjacent ones of the layers or all of the respectively adjacent ones of the layers are soldered together respectively around at least one, preferably more or all of the through-openings in at least one of the respectively adjacent layers. For particular preference, the soldering is thereby effected at least along a line which surrounds the corresponding through-opening and, particularly preferably, extends parallel to an edge of this through-opening. Preferably, the soldering can be effected in a region of constant width in the direction perpendicular to the longitudinal direction of the line. However, also courses with different widths are possible as an option. The latter is preferred in particular when the channels extend at different spacings relative to each other.

In a likewise advantageous embodiment of the invention, at least two adjacent ones of the layers or all adjacent ones of the layers can be soldered together also over the surface or the whole surface. The soldering can hereby be effected particularly advantageously in a continuous or batch furnace since the layers are connected at the same time not only in pairs. Planar, but not full-surface, connections are possible in particular when large island surfaces are configured between the channels in which, in addition to the circumferential, sufficiently wide soldering around the channels, no separate connection (and seal) is necessary in order to join the layers in a functionally reliable manner.

The soldering is effected preferably with the mentioned aluminium solder and/or ceramic solder. Full-surface soldering can be preferred from a procedural point of view because here particularly simple application of the solder is possible, for example by means of immersion, rolling or spraying.

In an advantageous embodiment of the invention, at least one of the layers can have a recess and/or an opening into which solder can flow. This makes it possible to operate with an excess of solder so that it is ensured that all of the portions to be soldered together are also soldered and, outside of the regions with recess and/or opening, as constant a solder thickness as possible is adjusted. A constant solder thickness is advantageous for the planarity and reproducibility of the thickness of the hydraulic system control plate. Excess solder can then flow into the recesses and/or via the openings, either into cavities provided for this purpose or externally. The recesses and/or openings are thereby disposed preferably such that they prevent undesired flow of solder in the direction of through-openings, in particular of critical through-openings with small cross-sections, so that it is ensured that all the through-openings are not affected detrimentally by the layer connection. This recess or opening is advantageously configured such that, if the hydraulic system control plate is soldered completely, this opening conducts no hydraulic fluid, i.e. is impermeable for the throughflow of hydraulic fluid. In a finished hydraulic system control plate, advantageously at least one recess and/or at least one opening is present in one layer which is filled partially or completely with solder.

In an advantageous embodiment of the invention, the hydraulic system control plate can have at least one magnet-, spring-, sieve-, sensor-, valve- and/or aperture element. A spring element can be formed for example by a spring plate being cut out in one of the layers, which spring plate is connected to a retaining region surrounding the latter, the spring plate being able to be connected to the retaining region via at least one spring arm, which is produced in the corresponding layer by incisions. Preferably, spring plate, spring arm and retaining region continue one into the other from a metal sheet, i.e. are preferably in one piece with the layer. Alternatively, the spring element can also be integrated as insert part in the hydraulic system control plate, in particular spring elements made of spring-hard metal sheets, preferably made of spring steel, are hereby preferably used. Likewise, more complex insert valves can be integrated. The relevant layer/layers of the hydraulic system control plate can hereby be provided with suitable receiving means devices.

An aperture element can be formed for example by one of the layers, which is disposed between two other ones of the layers, having a through-opening, the diameter of which is smaller than the diameter of through-openings of both adjacent layers, which through-openings overlap with the mentioned through-opening with a smaller diameter. An aperture (diaphragm) element can, on the other hand, also be formed optionally by two through-openings in mutually adjacent layers overlapping with each other only partially, here in particular oblong through-openings with a direction of extension essentially perpendicular to each other in the layer plane being preferred, as follows in fact from DE 10 2006 031 340 A1.

A magnet element can optionally be disposed in the form of a permanent magnet, for example in or on one of the layers, as is described in DE 20 2016 101 613, the content of which is herewith included in its entirety in this application.

The through-openings can basically have any shapes. Preferably, the through-openings have a closed edge in that layer through which they extend. In some of the layers, in particular in one or both of the outer layers, through-openings can be configured as simple round holes. In an advantageous embodiment, at least one of the through-openings can have an oblong extension in the corresponding layer so that this through-opening can form a channel. Such a through-opening can therefore extend along a line and have a constant width in the direction perpendicular to this line. If however interference contours are present in the hydraulic system control plate, it is advantageous to avoid these by reducing the width of this line in portions. It is also possible to change the width specifically, for example to reduce or to widen it over the course specifically, in order to bring about pressure increase- or pressure reduction effects in the throughflowing hydraulic fluid. Such a pressure stabilisation can be used for example in order to prevent cavitation effects.

A thickness of one, more or all of the layers of greater than or equal to 0.2 mm is preferred, preferably greater than or equal to 0.3 mm, particularly preferably greater than or equal to 0.5 mm and/or less than or equal to 4 mm, preferably less than or equal to 1.5 mm, particularly preferably less than or equal to 1 mm.

The hydraulic system control plate according to the invention can be termed carrier plate. It can be regarded as such as intermediate plate which carries the sealing layers or sealing coatings. The carrier plate can advantageously here have an uncoupling function for seals, sealing structures or sealing elements on the upper side and the lower side of the carrier plate, in particular if the sealing structures on the upper and lower side of the carrier plate extend in a projection into the plane of the carrier plate differently in portions. Preferably, the carrier plate has, on at least one or on both externally situated surfaces thereof, at least in regions or over the entire surface, an elastic coating and/or elastomer as sealing structure. Full-surface coatings can thereby have an essentially constant thickness. Preferably, sealing beads are formed from the elastic coating or the elastomer. With such sealing beads, the hydraulic system control plate can be sealed relative to the housing halves of the hydraulic system control or transmission control.

The hydraulic system control plate according to the invention can preferably also have at least two sealing layers, between which all of the previously mentioned layers, i.e. in particular the first layer, the at least one inner layer and the second layer, are disposed. The sealing layers can be disposed therefore on an upper and a lower side of the hydraulic system control plate. The sealing layers preferably have through-openings which coincide in projection of the sealing layer with the outermost of the layers in a common plane with through-openings in the outermost of the layers to which the corresponding sealing layer is adjacent. However, the diameter need not thereby be identical. In particular, the diameter of one through-opening in the sealing layer can be larger so that the throughflow cross-section through the through-opening in the carrier plate is delimited and hence controlled.

The sealing layers can advantageously comprise steel, constructional steel, spring steel or aluminium or consist thereof. The sealing layers can advantageously have a thickness of greater than or equal to 0.075 mm, preferably greater than or equal to 0.10 mm, particularly preferably greater than or equal to 0.15 mm and/or less than or equal to 0.6 mm, preferably less than or equal to 0.25 mm.

The sealing layers preferably have sealing structures which are formed from full-surface or partial elastomer coatings and/or are formed from beads, for example whole and/or half-beads, a bead top of the beads, preferably in the case of full beads, pointing away from the mentioned inner layer. In the case of incorporation of the hydraulic system control plate between the housing halves, the bead tops would therefore be orientated toward the housing halves.

The sealing layers can be connected conventionally to those of the layers on which they are disposed and possibly also to further layers adjacent to the latter, for example by means of one or more connection points, as is described in DE 10 2012 003 149. In particular in the case of sealing layers without an elastomer coating, the possibility also exists of joining the sealing layers to the layers integrally.

Likewise, it is possible optionally to use soft material as sealing layers, these being preferably glued on the outermost of the layer/layers.

It is advantageous with the layer structure according to the invention that the sealing layers or sealing structures can be configured freely on both sides of the layer arrangement, independently of each other, since the layer arrangement with the at least three layers supports the sealing layers or sealing structures.

Advantageously the hydraulic system control plate can be a transmission control plate.

Furthermore, the invention comprises a method for producing a hydraulic system control plate, in particular a hydraulic system control plate as was described previously. For this purpose, solder is applied on at least one plate of a base material, for example over the entire surface by means of rolling or in portions by means of a printing method. At least one first layer is produced from the at least one plate of the base material, for example stamped out. The application of the solder and the production of the at least one first layer can thereby be effected in any sequence. Subsequently, at least three layers, one of which is the at least one first layer, are subsequently disposed one on the other such that all directly adjacent ones of the layers abut via at least one surface coated with solder, and the layers disposed one on the other are heated to a melting temperature of the solder so that the layers are soldered together.

It is not thereby necessary that all of the at least three layers are produced from the base material. Rather, at least one, preferably at least two, of the at least three layers can be produced not from the plate of base material. It is essential that, on each interface between two layers to be joined together on the surface of at least one of the layers, solder is present.

In the following, the invention is intended to be explained with reference to some Figures, by way of example. The same reference numbers characterise thereby the same or corresponding features. The features shown in the examples can also be produced independently of the concrete example and be combined amongst the examples.

There are shown:

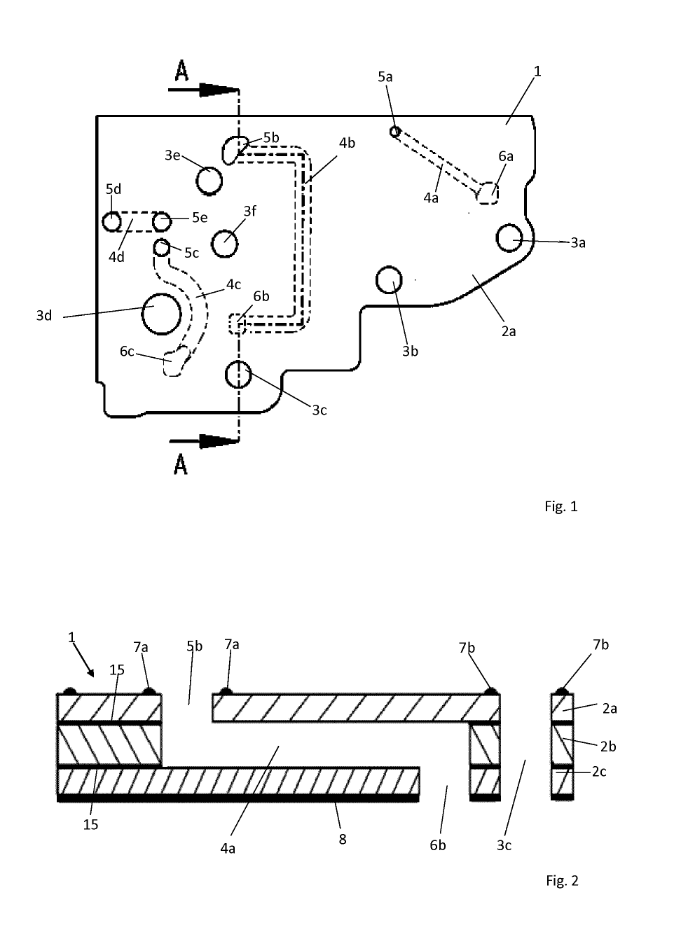

FIG. 1 a plan view on a hydraulic system control plate according to the invention,

FIG. 2 a section through the hydraulic system control plate shown in FIG. 1,

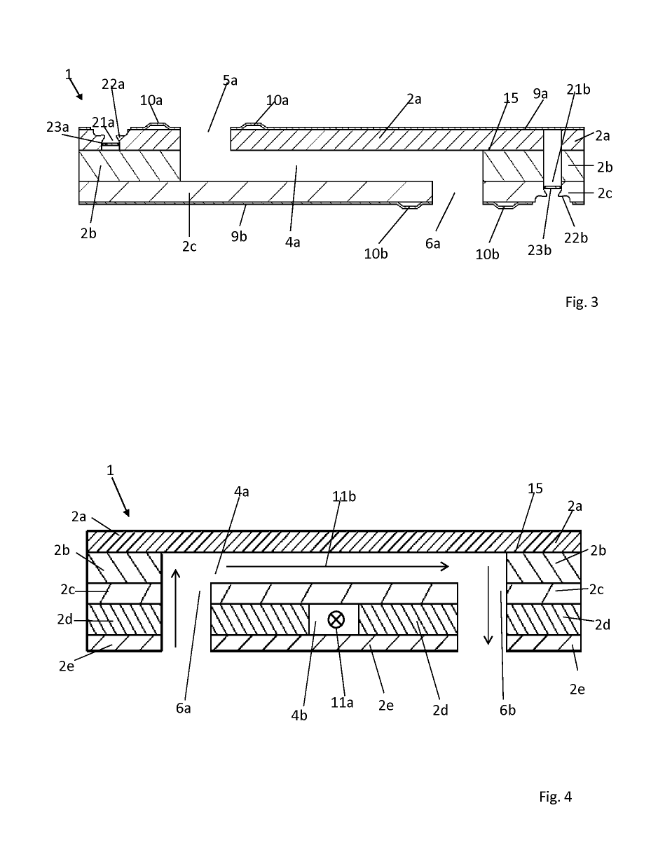

FIG. 3 a hydraulic system control plate according to the invention with sealing layers disposed thereon,

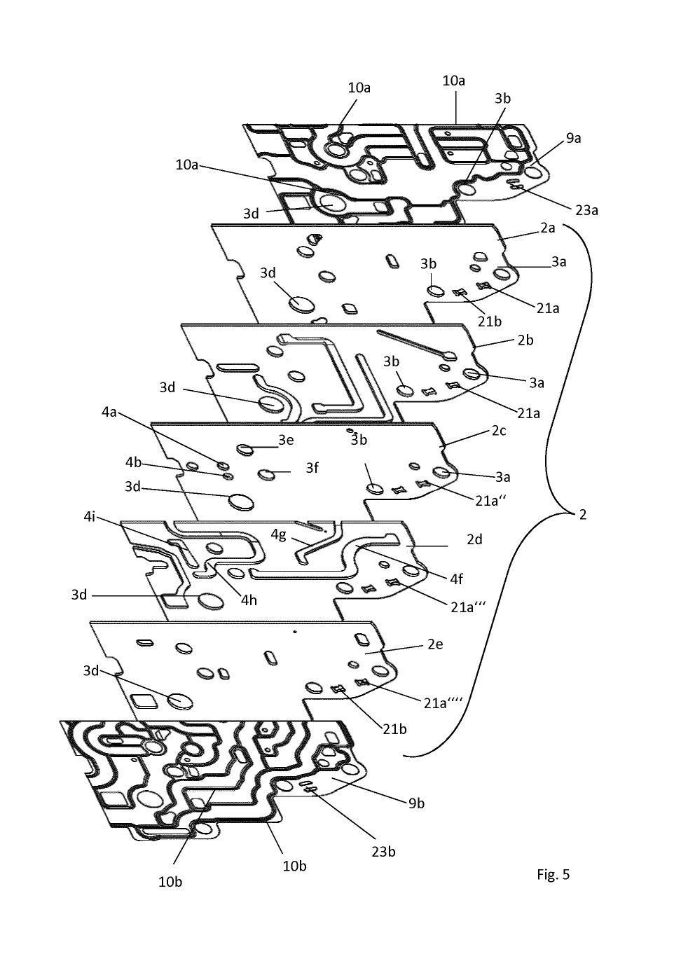

FIG. 4 a section through a hydraulic system control plate according to the invention,

FIG. 5 an exploded drawing of a hydraulic system control plate according to the invention with sealing layers, and

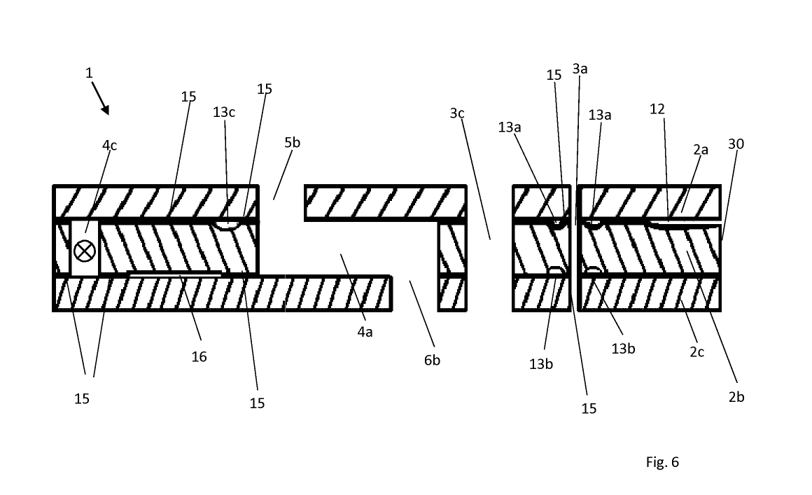

FIG. 6 an embodiment of the invention with layers which have openings for receiving solder.

FIG. 1 shows a hydraulic system control plate 1 according to the invention which can be for example a transmission control plate 1. FIG. 1 thereby shows a plan view on an uppermost layer 2a. Structures of the uppermost layer 2a are drawn here with continuous lines. Structures which are situated below the uppermost layer 2a are drawn in broken lines in FIG. 1. Broken-line structures are therefore covered by the uppermost layer 2a. The broken-line structures are accommodated in further layers 2b and/or 2c which are disposed under the uppermost layer 2a.

The hydraulic system control plate 1 shown in FIG. 1 has some, in the illustrated example, six through-openings 3a to 3f which extend through all the layers 2a, 2b and 2c with a throughflow direction perpendicular to the layer plane. These through-openings 3a to 3f are therefore formed by each of the layers 2a, 2b and 2c having openings which have identical dimensions in all layers and are disposed exactly one above the other. Such openings can serve as throughflow openings for hydraulic fluid or as through-openings for connecting elements with which housing halves of one hydraulic system control can be joined together through the hydraulic system control plate 1.

In the example shown in FIG. 1, the hydraulic system control plate 1 has, furthermore, through-openings 4a, 4b, 4c and 4d which are introduced into an inner layer 2b of the mentioned layers 2a, 2b and 2c. These through-openings 4a to 4d extend in the inner layer 2b along lines and have a constant width in the direction perpendicular to the corresponding line in the plane of the inner layer.

The through-openings 4a to 4d are delimited respectively on at least one part of their extension by the two adjacent layers 2a and 2c in the direction perpendicular to the layer plane. In this way, the through-openings 4a to 4d form channels in the inner layer between the first layer 2a and the second layer 2c.

At their ends, the through-openings 4a to 4d of the inner layer 2b respectively overlap with an opening 5a to 5e of the layer 2a or 6a to 6c in the layer 2c. In this way, the through-openings 4a to 4d in the inner layer 2b form channels in the hydraulic system control plate in which fluid can flow between openings 5a to 5e or 6a to 6c of the first layer 2a and/or of the second layer 2c.

FIG. 1 shows a few different possible forms of such channels. Thus the through-opening 4b in the inner layer 2b forms a U-shaped channel, one end of which opens outwards in an opening 5b in the upper layer 2a and the other end of which opens outwards in an opening 6b in the lower layer 2c. The opening 4a forms a simple straight channel which extends from an opening 5a in the upper layer 2a to an opening 6a in the lower layer 2c. The channel 4c extends, starting from an opening 5c in the upper layer 2a, to an opening 6c in the lower layer 2c, said channel surrounding the straight through-opening 3d. The opening 4d in the inner layer 2b finally extends from an opening 5d in the upper layer 2a to a further opening 5e in the upper layer 2a. In summary, channels can therefore be configured, inter alia, in the inner layer 2b, which channels overlap at both ends with openings in the upper layer 2a, or overlap at both ends with openings in the lower layer 2c or overlap at one end with an opening in the upper layer 2a and at the other end with an opening in the lower layer 2c. The openings in the inner layer 2b can thereby be for example straight, angled or extend in a circle. A large number of other geometries is possible. Furthermore, the openings 4 in the inner layer 2b can also extend in a planar manner, for example as circles or rectangles. It is also conceivable that some of the openings 4 have branches and consequently overlap at more than two ends with openings in adjacent layers 2a or 2c.

FIG. 2 shows schematically and not true-to-scale, a section along the section line A through the hydraulic system control plate shown in FIG. 1. There can be seen, on the one hand, the straight through-opening 3c, which penetrates all the layers 2a, 2b and 2c such that the layers 2a, 2b and 2c together form a cylindrical wall of the opening 3c. Furthermore, there can be seen the through-opening 4a in the inner layer 2b, which overlaps at one end thereof with the opening 5b in the upper layer 2a, and at the opposite end thereof with the opening 6b of the lower layer 2c.

The hydraulic system control plate 1 shown in FIG. 2 has in addition sealing structures 7a, 7b and 8, by means of which the openings 5b, 6b and 3c are sealed relative to structures abutting at the top and bottom on the hydraulic system control plate, such as for example housing halves of a hydraulic system control. The sealing structures 7a and 7b are configured thereby on the upper layer 2a as sealing lines which respectively surround the openings 5b and 3c of the upper layer 2a. The sealing line 7a thereby surrounds the opening 5b and the sealing line 7b the opening 3c. The sealing lines 7a and 7b can hereby be produced by moulded-on rubber. The plan view of FIG. 1 omits the explicit illustration of the sealing structures 7a, 7b.

On that side of the lower layer 2c, orientated away from the inner layer 2b, the seal is produced by a planar coating of the corresponding lower side of the lower layer 2c. The sealing material 8 can thereby cover completely the corresponding lower side of the layer 2c with the exception of the openings 6b, 3c and further openings.

The layers 2a, 2c, in the example of FIG. 2, are stamped out of the same aluminium sheet which is coated on one side by means of immersion with ceramic solder and is 0.2 mm thick, whilst the layer 2b is produced from an uncoated, 0.3 mm thick aluminium sheet. The layer thickness of the ceramic solder is thereby approx 0.03 mm. It is clear from FIG. 2 that the three layers 2a, 2b and 2c respectively are soldered together respectively in pairs 2a-2b and 2b-2c over their entire surface, via for example a ceramic solder 15, as a result of which also the channel formed by the openings 5b, 4a and 6b between the layers 2a, 2b and 2c has no leakage points. Application of the sealing material 8 or of the sealing lines 7a, 7b is effected here on the already soldered three-layer hydraulic control plate 1.

FIG. 3 shows a section through an example of a different embodiment of a hydraulic system control plate 1 according to the invention. As in FIGS. 1 and 2, the hydraulic system control plate also here has a first layer 2a, a second layer 2c and an inner layer 2b disposed between the first and the second layer. As shown in FIG. 2, a through-opening 4a is also configured in FIG. 3 in the inner layer 2b, which through-opening is delimited in regions by the adjacent layers 2a and 2c and overlaps at their ends with openings 5a in the first layer 2a and 6a in the second layer 2c so that a channel is formed which extends from the opening 5a in the first layer 2a through the inner layer 2b to the opening 6a in the second layer 2c. In turn, the mutually adjacent layers 2a and 2b and also 2b and 2c respectively are soldered together in pairs over the entire surface by means of a solder 15, here now however by means of an aluminium solder. The layers 2a, 2b and 2c were manufactured from aluminium sheets of different thicknesses, of which only the metal sheet out of which the inner layer 2b is stamped is coated on both sides over the entire surface with solder.

In the example shown in FIG. 3, the hydraulic system control plate 1 according to the invention has two sealing layers 9a and 9b, between which all of the layers 2a, 2b and 2c are disposed. The sealing layers 9a and/or 9b can have for example steel, constructional steel, spring steel or aluminium or consist thereof.

The sealing layers 9a and 9b have beads 10a or 10b which surround the openings 5a or 6a in the corresponding layer 2a or 2c. A bead top of the full beads 10a and 10b is thereby orientated respectively away from the inner layer 2b.

The connection of the sealing layers 9a or 9b to the layers 2a or 2c is effected here only locally, as known from WO 2013011132 A1. For this purpose, the uppermost layer 2a is recessed in section 21a, a web 23a of the sealing layer 9a, separated only partially, was formed in the plane of the layer 2a and is retained there by two projections 22a of the layer 2a. The other illustrated connection point is configured comparably, an only partially separated web 23b of the sealing layer 9b was formed in the plane of the layer 2c and is retained there by two projections 22b of the layer 2c. However, the recess 21b here is provided not only in the layer 2c but continues in both other layers 2b, 2a. The recess 21b could hence be used as particularly large reservoir for receiving excess solder, as is explained also with reference to FIG. 6.

FIG. 4 shows a section through a further embodiment of a hydraulic system control plate 1 according to the invention which has five layers 2a, 2b, 2c, 2d and 2e. A through-opening 4a is thereby configured in an inner layer 2b and extends from an opening 6a in an adjacent layer 2c to an opening 6b in the adjacent layer 2c. The openings 6a and 6b in the layer 2c continue into those layers 2d and 2e disposed on that side orientated away from the layer 2b into openings in these layers 2d and 2e which are congruent with the openings 6a and 6b. In this way, a channel is configured in the hydraulic system control plate 1 and extends from an opening in the layer 2e to a further opening in the layer 2e.

The embodiment shown in FIG. 4 has in addition a through-opening 4b in the layer 2d, which is configured in this through-opening 2d along a longitudinal direction as an oblong. The longitudinal direction of this through-opening 4b is thereby perpendicular on the Figure plane. The through-opening 4b is thereby delimited, at least in regions, by the adjacent layers 2c and 2e in the direction perpendicular to the plane of the layers. In this way, the through-opening 4b forms a channel, the throughflow direction 1 a of which is perpendicular to a throughflow direction 11b, of the through-opening 4a in the inner layer 2b. The embodiment of FIG. 4 hence enables intersection of channels.

All of the layers 2a to 2e, in the illustrated example, are connected together, preferably in pairs over the entire surface via a solder joint 15, this being illustrated explicitly in FIG. 4 only for the layer pair 2a-2b. For this purpose, the layers 2b and 2d are stamped out of a metal sheet coated on both sides with aluminium solder with a sheet thickness of 0.25 mm and held between the uncoated layers 2a, 2c, 2e. The solder joint 15 closes the two above-mentioned channels at the interfaces between the respective layers.

FIG. 5 shows an embodiment of the hydraulic system control plate according to the invention, by way of example, with five layers 2a, 2b, 2c, 2d and 2e which are disposed between two sealing layers 9a and 9b as an exploded drawing, i.e. in the non-connected state. For the sake of clarity, an illustration of the surface portions coated with solder is dispensed with. The five layers 2a, 2b, 2c, 2d and 2e form a carrier plate 2 in the connected state. Only one section of the respective layer respectively is thereby shown. The respective left and upper edge represents the delimitation of the illustrated section, the actual layer would continue beyond these lines. The layers 2a to 2e and also the sealing layers 9a and 9b have identical outer silhouettes, as is clear with reference to the right and lower outer edge of the respective layer and therefore form, in the state disposed one above the other, a stack with straight outer walls in the direction perpendicular to the layer plane.

The layers 2a, 2b and 2c form essentially the structures shown in FIGS. 1 and 2 and described there so that reference should be made to the description there. In FIG. 5, on that side of the layer 2c, orientated away from the layer 2b, two further layers 2d and 2e are thereby disposed. The layer 2d thereby has oblong through-openings 4f, 4g, 4h and 4i which are delimited in regions by the adjacent layers 2c and 2e in the direction perpendicular to the layer plane and overlap at their ends with openings in layers 2c and 2e adjacent thereto, for example the opening 4a of the layer 2c overlaps with the opening 4i of the layer 2d, just as the opening 4b with the opening 4h. In the example shown in FIG. 5, it is clear that the through-openings 4h and 4g continue beyond the section of the hydraulic system control plate 1 illustrated in FIG. 5.

The sealing plates 9a and 9b have a large number of sealing beads 10a, 10b which seal the openings relative to the non-illustrated housing halves of the hydraulic system control. The sealing plates 9a and 9b are configured such that they can be connected together locally respectively with all of the layers 2a to 2e in the manner as clarified in FIG. 3, the relevant through-openings 21a to 21a″″ or 21b to 21b″″ are thereby configured in all the layers 2a to 2e.

FIG. 6 shows a hydraulic system control plate which is constructed similarly to that shown in FIG. 2. In addition to the embodiment shown in FIG. 2, the control plate shown in FIG. 6 has recesses 13a, 13b and 13c and also an opening 12 in the inner layer 2b which enable a flow of solder in the direction parallel to the plane of the layers. The recesses 13a, 13b thereby have respectively an annular configuration so that they delimit the through-opening 3a in both interfaces between the layer pairs 2a-2b and 2b-2c. As a result, it is ensured for the circumferential soldering 15 around the through-opening 3a that excess solder flows into the respective recess 13a or 13b and the through-opening 3a which is susceptible because of its small cross-section does not suffer a cross-sectional reduction or even-blockage. The recess 13c extends in the direction parallel to the layer plane in an oblong, namely into the drawing plane. In addition, a linear soldering 15 which has a constant width at least in portions is formed. The opening 12 which is accompanied by a recess in the inner layer, but extends up to the outer edge 30 of the layer 2b or of the hydraulic system control plate 1, offers the possibility that solder is discharged outwards. Advantageously, comparable openings are present at regular spacings, for example parallel to the opening 12 illustrated here, behind or in front of the drawing plane. Likewise, such openings can open into through-openings 21 which are provided exclusively for local connection between sealing layers 10 and layers 2, as is indicated already with reference to FIG. 3. Even if in FIG. 6 the regions in which the inner layer 2b has recesses or an opening, are illustrated such that, in them, no planar connection between the layers takes place, this is not necessarily the case. For better illustration of the recesses or openings, an illustration of their filling was completely dispensed with here. Normally, these are however filled at least partially with solder in a soldered hydraulic system control plate. Advantageously, the soldering of the layers is effected with a large solder excess so that all of the surfaces of the layers provided for the connection are connected together in a planar manner, however, because of the discharge possibilities, the solder thickness can be adjusted uniformly to the desired extent at the same time. Nevertheless, it is possible to undertake the soldering 15 not over the entire surface but to configure individual island-like regions 16 as solder-free and hence without a connection between the layers. For this purpose, the solder is applied preferably only on the desired regions by means of a printing method. All interfaces adjacent to channels between the layers 2 should preferably be sufficiently soldered.

1-23. (canceled)

24. A hydraulic system control plate, comprising:
at least one first layer, at least one second layer and at least one inner layer disposed between the first layer and the second layer,
the at least one inner layer having at least one through-opening which is delimited, on at least one part of its extension situated in a surface of the inner layer, by the first layer and the second layer in the direction perpendicular to the surface of the inner layer,
one, several or all of the layers comprising aluminium, and
at least two adjacent ones of the layers or all of the layers, which are adjacent to each other in pairs, being soldered together at least in regions.

25. The hydraulic system control plate according to claim 24, wherein one, several or all of the layers comprise aluminium solder and/or ceramic solder on at least one part of the surface thereof or on the entire surface thereof.

26. The hydraulic system control plate according to claim 24, wherein at least two adjacent ones of the layers or all of the adjacent ones of the layers being soldered together respectively around through-openings in at least one of the respective adjacent layers.

27. The hydraulic system control plate according to claim 24, wherein at least two adjacent layers or all of the adjacent layers are soldered together over the whole surface.

28. The hydraulic system control plate according to claim 24, wherein, the plates which are soldered together being soldered together with aluminium solder or with ceramic solder.

29. The hydraulic system control plate according to claim 24, wherein at least one of the layers having at least one recess and/or at least one opening into which solder can flow and/or being filled partially or completely with solder.

30. The hydraulic system control plate according to claim 24, wherein the first layer and/or the second layer having at least one through-opening which overlaps with the through-opening of the at least one inner layer at least in portions and/or is connected to the through-opening of the at least one inner layer in a fluid-permeable manner.

31. The hydraulic system control plate according to claim 30, wherein the first and the second layer having respectively one of the through-openings which do not overlap each other.

32. The hydraulic system control plate according to claim 24, wherein at least one further layer is disposed on a side of the first layer which is orientated away from the inner layer and/or at least one further layer is disposed on a side of the second layer which is orientated away from the second layer,
the at least one further layers each delimiting a through-opening of an adjacent one of the layers on at least one part of the extension of this through-opening in the corresponding adjacent layer in the direction perpendicular to the surface of the corresponding adjacent layer, and/or
the at least one further layers each having at least one through-opening which overlaps with a through-opening of an adjacent one of the layers and/or is connected to a through-opening of an adjacent one of the layers in a fluid-permeable manner.

33. The hydraulic system control plate according to claim 32, wherein at least one of the at least one through-openings being a channel with an oblong extension in the corresponding layer.

34. The hydraulic system control plate according to claim 24, wherein a thickness of one, several or all of the layers is greater than or equal to 0.2 mm, and/or less than or equal to 4 mm.

35. The hydraulic system control plate according to claim 24, wherein the layers extend in a planar manner.

36. The hydraulic system control plate according to claim 24, wherein all of the layers together form a carrier plate.

37. The hydraulic system control plate according to claim 36, wherein an elastic coating and/or or sealing beads comprising elastomer are applied on at least one or on both surfaces of the carrier plate which are situated externally, at least in regions or over the whole surface.

38. The hydraulic system control plate according to claim 24, further comprising two sealing layers between which are disposed all of the layers.

39. The hydraulic system control plate according to claim 38, wherein the sealing layers are produced from steel, constructional steel, spring steel or aluminium.

40. The hydraulic system control plate according to claim 38, wherein the sealing layers have a thickness of greater than or equal to 0.075 mm and/or less than or equal to 0.6 mm.

41. The hydraulic system control plate according to claim 38, wherein the sealing layers having sealing structures, the sealing structures including elastomer coatings at least on that side of the sealing layers which is orientated away from the inner layer, and/or beads, including beads, the bead top of which points away from the inner layer.

42. The hydraulic system control plate according to claim 38, wherein the sealing layers each have at least one through-opening which is flush with a through-opening of the one of the layers which is adjacent to the corresponding sealing layer, and is congruent.

43. The hydraulic system control plate according to claim 24, wherein the hydraulic system control plate is configured as a transmission plate.

44. A method for producing a hydraulic system control plate,
solder being applied on at least one plate of a base material,
at least one layer being produced from the at least one plate of the base material,
at least three layers comprising the at least one first layer being disposed one on the other such that all the directly adjacent ones of the layers abut one on the other via at least one surface which is coated with solder,
and the layers which are disposed one on the other being heated to a melting temperature of the solder.

45. The method according to claim 44, wherein at least one of the at least three layers are not produced from the plate of the base material.
